(19) United States
(12) Patent Application Publication
(10) Pub. No.: US 2026/0346744 A1
(43) Pub. Date: Nov. 5, 2026

(54) POWER CONVERSION DEVICE, VEHICLE, AND POWER SYSTEM

(71) Applicant: Panasonic Automotive Systems Co., Ltd., Kanagawa (JP)

(72) Inventor: Atsushi IISAKA, Kanagawa (JP)

(73) Assignee: Panasonic Automotive Systems Co., Ltd., Kanagawa (JP)

(21) Appl. No.: 19/532,636

(22) Filed: Feb. 6, 2026

(30) Foreign Application Priority Data
Feb. 14, 2025 (JP) 2025-022433

(51) Int. Cl. B60L 53/20; B60L 53/16; B60L 53/18; B60L 55/00; H02J 3/32; H02J 3/388; H02J 9/06

(52) U.S. Cl. CPC B60L 53/20; B60L 53/16; B60L 53/18; B60L 55/00; H02J 3/322; H02J 3/388; H02J 9/063; B60L 2210/30; B60L 2210/42

(57) ABSTRACT

A power conversion device includes: a power convertor including an AC-side input/output terminal electrically connected to a charge/discharge socket to which a charge/discharge cable is detachably connected, and a DC-side input/output terminal; a neutral point connection switch disposed between a neutral point of a pair of power lines of the AC-side input/output terminal and a functional grounding line at a chassis potential electrically connected to a protective earth line of the charge/discharge cable connected to the charge/discharge socket; and a first controller configured to control an islanded operation causing the power convertor to convert DC power input from the DC-side input/output terminal into AC power to output the AC power from the AC-side input/output terminal with the neutral point connection switch kept on by the first controller to establish conduction between the neutral point of the AC-side input/output terminal and the functional grounding line at the chassis potential.

### CROSS-REFERENCE TO RELATED APPLICATIONS

This application is based upon and claims the benefit of priority from Japanese Patent Application No. 2025-022433, filed on Feb. 14, 2025, the entire contents of which are incorporated herein by reference.

### FIELD

The present disclosure relates to a power conversion device, a vehicle, and a power system.

### BACKGROUND

There is known a technique in which a battery mounted on electric vehicles (EVs), plug-in hybrid electric vehicles (PHEVs), or other electric vehicles is charged, using commercial power supplied from a power grid such as that of a house, or discharged so that the discharged power is utilized as a power source for the house. In a consumer receiving power supply from a single-phase, three-wire power grid of a house or the like, both a single-phase 200 V between a pair of voltage lines and a single-phase 100 V between either one of the pair of voltage lines and a neutral line, are utilized via a distribution board.

Under these circumstances, even if a single-phase 200 V is supplied between the pair of voltage lines of the consumer from an on-board charger using power of an on-board battery of the vehicle, the potential of the neutral line becomes undefined or floating at the consumer's house, preventing the voltage between the voltage line and neutral line from being used as the single-phase 100 V. For example, Japanese Unexamined Patent Publication No 2014-060834 discloses a charging/discharging system that functionally grounds the neutral point of the power conversion unit to the chassis potential, enabling a power storage device to be used as a power source in a case where power is not supplied from either the single-phase 200 V or single-phase 100 V power grids.

However, under the standards for on-board chargers, the neutral point of the power conversion unit is not allowed to be functionally grounded to the chassis potential. This leaves room for improvement in the utilization of an on-board battery as a power source by a consumer receiving power supply from a single-phase three-wire power grid.

### SUMMARY

A power conversion device according to the present disclosure includes a power convertor, a neutral point connection switch, and a first controller. The power convertor includes an AC-side input/output terminal electrically connected to a charge/discharge socket to which a charge/discharge cable is detachably connected to input and output AC power, and a DC-side input/output terminal configured to input and output DC power. The power convertor is configured to convert power input from one of the AC-side input/output terminal and the DC-side input/output terminal between AC power and DC power and output converted power from another of the AC-side input/output terminal and the DC-side input/output terminal. The neutral point connection switch is disposed between a neutral point of a pair of power lines of the AC-side input/output terminal and a functional grounding line at a chassis potential electrically connected to a protective earth line of the charge/discharge cable connected to the charge/discharge socket. The first is controller configured to control operations of the power convertor and the neutral point connection switch. The first controller is configured to control an islanded operation causing the power convertor to convert DC power input from the DC-side input/output terminal into AC power to output the AC power from the AC-side input/output terminal with the neutral point connection switch kept on by the first controller to establish conduction between the neutral point of the AC-side input/output terminal and the functional grounding line at the chassis potential.

### BRIEF DESCRIPTION OF THE DRAWINGS

FIG. 1 is a diagram illustrating an exemplary configuration of a power system according to a first embodiment;

FIG. 2 is a diagram illustrating an exemplary configuration of the power system according to the first embodiment;

FIG. 3 is a flowchart illustrating an exemplary operation of the power system according to the first embodiment in the islanded operation;

FIG. 4 is a diagram illustrating an example of the connection state in the islanded operation upon connection of a first vehicle to the power system according to the first embodiment;

FIG. 5 is a diagram illustrating an exemplary configuration of a power system according to a modification of the first embodiment;

FIG. 6 is a diagram illustrating an exemplary configuration of a power system according to a second embodiment;

FIG. 7 is a flowchart illustrating an exemplary operation of the power system according to the second embodiment in the islanded operation;

FIG. 8 is a diagram illustrating an example of the connection state in the islanded operation upon connection of a second vehicle to the power system according to the second embodiment;

FIG. 9 is a diagram illustrating an exemplary configuration of a power system according to a third embodiment; and

FIG. 10 is a flowchart illustrating an exemplary operation of the power system according to the third embodiment in the islanded operation.

### DETAILED DESCRIPTION

Embodiments of a power conversion device (on-board charger), vehicle, power supply apparatus, and power system according to the present disclosure will be described below with reference to the drawings.

Note that in the description of the present disclosure, components having the same or substantially the same function as those previously described with reference to preceding drawings are denoted by the same reference numerals, and their description may be omitted as appropriate. Furthermore, even in representing the same or substantially the same components, the dimensions and ratios may differ among drawings. In addition, for example, to ensure the visibility of the drawings, only major components may be denoted by reference numerals in the description of each drawing, and even if components having the same or substantially the same function as those described with reference to the preceding drawings are illustrated, reference numerals may not be provided thereto.

Note that in the description of the present disclosure, components having the same or substantially the same function may be distinguished by appending alphanumeric characters and/or symbols to the ends of the reference numerals. Alternatively, in the case where multiple components having the same or substantially the same function are not to be distinguished, such alphanumeric characters and/or symbols appended to the ends of the reference numerals may be omitted, and the components may be collectively denoted.

### First Embodiment

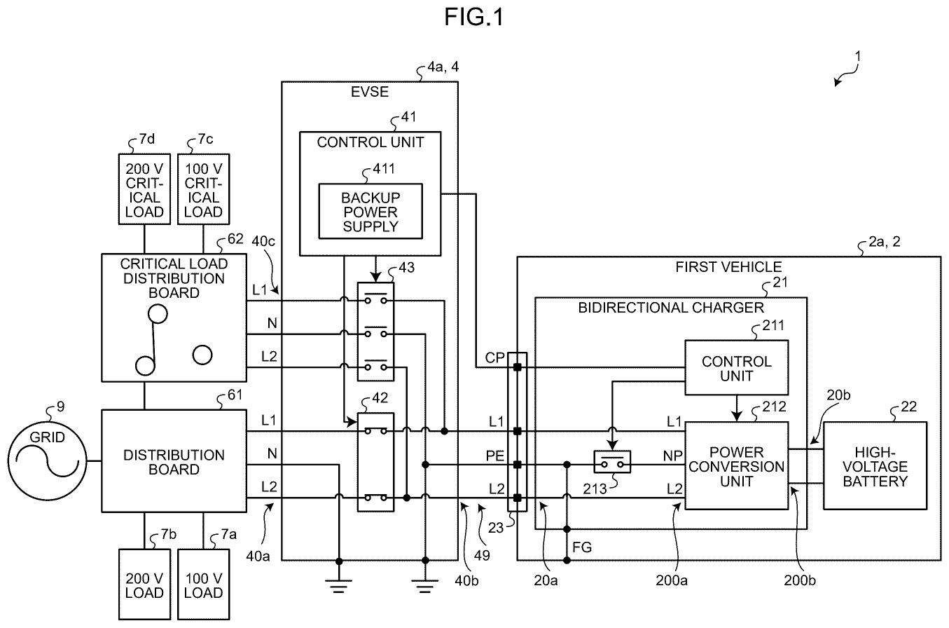

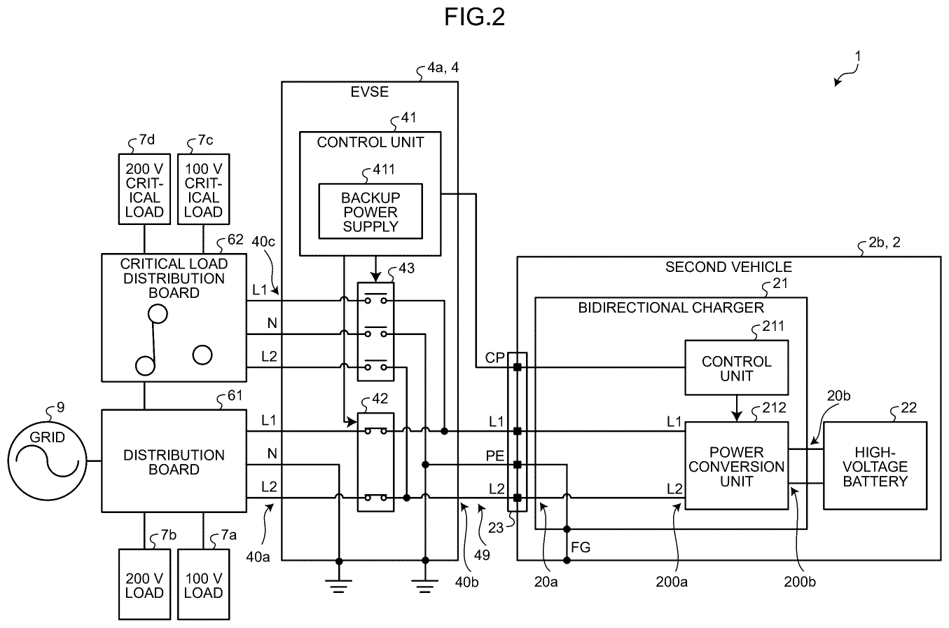

FIGS. 1 and 2 are diagrams illustrating an exemplary configuration of a power system 1 according to a first embodiment. FIG. 1 illustrates an example in a case where a first vehicle is connected. FIG. 2 illustrates an example in a case where a second vehicle is connected. Moreover, FIGS. 1 and 2 illustrate a connection state of each of the grid-connected operation and grid-interconnection operation.

As illustrated in FIGS. 1 and 2, the power system 1 includes a vehicle 2, an electric vehicle supply equipment (EVSE) 4, a distribution board 61, a critical load distribution board 62, a 100 V load 7a, a 200 V load 7b, a 100 V critical load 7c, and a 200 V critical load 7d.

The power system 1 is electrically connected to a grid 9. The power system 1 is a single-phase, three-wire system that receives AC power from the grid 9. In the present disclosure, the power system 1 is supplied with single-phase 200 V AC power from the grid 9, with a potential difference between a pair of voltage lines being single-phase 200 V and a potential difference between one of the pair of voltage lines and the neutral line being single-phase 100 V.

The grid 9 is a power grid that transmits AC power (e.g., commercial power) from power facilities such as power plants and substations and supplies the AC power to consumers such as houses. Moreover, the AC power supplied from the grid 9 to power system 1 is not limited to single-phase 200 V, and can be other AC power such as single-phase 240 V.

The vehicle 2 is, by way of example, an electric vehicle (EV), a plug-in hybrid electric vehicle (PHEV), or other electric vehicles. In this example, the vehicle 2 according to the present embodiment is an example of a mobile body. The mobile body can be any type of mobile body configured to be driven by power from a high-voltage battery 22, such as a passenger car, cargo vehicle, van, motorcycle, electric kick scooter, ship, aircraft, construction machinery, or agricultural machinery. Moreover, the technique according to the present embodiment is not limited to mobile bodies such as the vehicle 2, but can also be applied to various power conversion devices installed in, for example, amusement facilities or uninterruptible power supplies.

As illustrated in FIGS. 1 and 2, the vehicle 2 has a bidirectional charger 21, the high-voltage battery 22, and a charge/discharge socket 23.

The bidirectional charger 21 is electrically connected between the high-voltage battery 22 and the charge/discharge socket 23. The bidirectional charger 21 has an AC-side input/output terminal 20a electrically connected to the charge/discharge socket 23 via a pair of power lines L1 and L2, a protective earth (PE) line, and a control pilot (CP) line. Furthermore, the bidirectional charger 21 has a DC-side input/output terminal 20b electrically connected to the high-voltage battery 22 via a pair of power lines.

In this example, the bidirectional charger 21 is a charger (on-board charger) installed in the vehicle 2 and is an example of a power conversion device. In addition, each of the pair of power lines L1 and L2 is an example of a voltage line through which a single-phase current flows. Additionally, the control pilot line (CP) is an example of a control line.

As illustrated in FIGS. 1 and 2, the bidirectional charger 21 includes a control unit 211 and a power conversion unit (power convertor) 212. In this example, the control unit 211 is an example of a first control unit (first controller).

The control unit 211 is an integrated circuit (IC) for control configured to control the operation of each component of the bidirectional charger 21. The control unit 211 is electrically connected to the power conversion unit 212 via a control line. The control unit 211 controls the operation of the power conversion unit 212. For example, the control unit 211 controls the operation of the power conversion unit 212 in accordance with a control signal received from an EVSE 4a via the control pilot line.

In one example, the control unit 211 controls grid-connected operation. In the grid-connected operation, the control unit 211 causes the power conversion unit 212 to convert AC power input from the AC-side input/output terminal 20a into DC power and output the DC power from the DC-side input/output terminal 20b. In the grid-connected operation, the potential difference between the pair of power lines L1 and L2 at the AC-side input/output terminal 20a of the power conversion unit 212 is, for example, single-phase 200 V, which is an example of a first voltage. The DC power output from the DC-side input/output terminal 20b is supplied to the high-voltage battery 22.

In one example, the control unit 211 controls grid-interconnection operation. In the grid-interconnection operation, the control unit 211 causes the power conversion unit 212 to convert DC power input from the high-voltage battery 22 via the DC-side input/output terminal 20b into AC power and output the AC power from the AC-side input/output terminal 20a. In the grid-interconnection operation, the potential difference between the pair of power lines L1 and L2 at the AC-side input/output terminal 20a of the power conversion unit 212 is, for example, single-phase 200 V, which is an example of the first voltage. The AC power output from the AC-side input/output terminal 20a is supplied to the EVSE 4a via a charge/discharge cable 49.

The power conversion unit 212 operates under the control of the control unit 211. The power conversion unit 212 includes an AC-side input/output terminal 200a and a DC-side input/output terminal 200b. The AC-side input/output terminal 200a is electrically connected to the AC-side input/output terminal 20a of the bidirectional charger 21. The DC-side input/output terminal 200b is electrically connected to the DC-side input/output terminal 20b of the bidirectional charger 21.

The AC-side input/output terminal 200a inputs and outputs AC power. The DC-side input/output terminal 200b inputs and outputs DC power. The power conversion unit 212 converts power input from either of the AC-side input/output terminal 200a or the DC-side input/output terminal 200b into AC or DC power, and outputs the converted power from the other input/output terminal of either the AC-side input/output terminal 200a or the DC-side input/output terminal 200b.

As illustrated in FIG. 1, the bidirectional charger 21 in the first vehicle 2a further includes a neutral point connection switch 213. On the other hand, as illustrated in FIG. 2, the bidirectional charger 21 in the second vehicle 2b does not include a neutral point connection switch. In other words, the first vehicle 2a is a vehicle 2 provided with the neutral point connection switch 213. Similarly, the second vehicle 2b is a vehicle 2 not provided with a neutral point connection switch 213.

The neutral point connection switch 213 operates under the control of the control unit 211 of the first vehicle 2a. The neutral point connection switch 213 is provided between a neutral point NP of a pair of power lines L1 and L2 at the AC-side input/output terminal 200a of the power conversion unit 212 and a functional grounding line FG at a chassis potential. The neutral point connection switch 213 switches between conduction and disconnection between the neutral point NP of the pair of power lines L1 and L2 at the AC-side input/output terminal 200a of the power conversion unit 212 and the functional grounding line FG at the chassis potential.

In this example, in the first vehicle 2a, the functional grounding line FG at the chassis potential is electrically connected to a protective earth terminal of the charge/discharge socket 23 via a protective earth line PE. In other words, the neutral point connection switch 213 is provided between the neutral point NP of the pair of power lines L1 and L2 at the AC-side input/output terminal 200a of the power conversion unit 212 and the protective earth line PE. Additionally, the neutral point connection switch 213 also switches between conduction and disconnection between the neutral point NP of the pair of power lines L1 and L2 at the AC-side input/output terminal 200a of the power conversion unit 212 and the protective earth line PE.

The control unit 211 of the first vehicle 2a is electrically connected to the neutral point connection switch 213 via a control line. The control unit 211 of the first vehicle 2a further controls the operation of the neutral point connection switch 213.

In one example, in the grid-connected operation, the control unit 211 of the first vehicle 2a turns off the neutral point connection switch 213 to establish a state in which the neutral point NP of the AC-side input/output terminal 200a is cut off from the protective earth line PE. In this state, the control unit 211 of the first vehicle 2a causes the power conversion unit 212 to convert the AC power input from the AC-side input/output terminal 200a into DC power and output the DC power from the DC-side input/output terminal 200b.

In one example, in the grid-interconnection operation, the control unit 211 of the first vehicle 2a turns off the neutral point connection switch 213 to establish a state in which the neutral point NP of the AC-side input/output terminal 200a is cut off from the protective earth line PE. In this state, the control unit 211 of the first vehicle 2a causes the power conversion unit 212 to convert the DC power input from the DC-side input/output terminal 200b into AC power and output the AC power from the AC-side input/output terminal 200a.

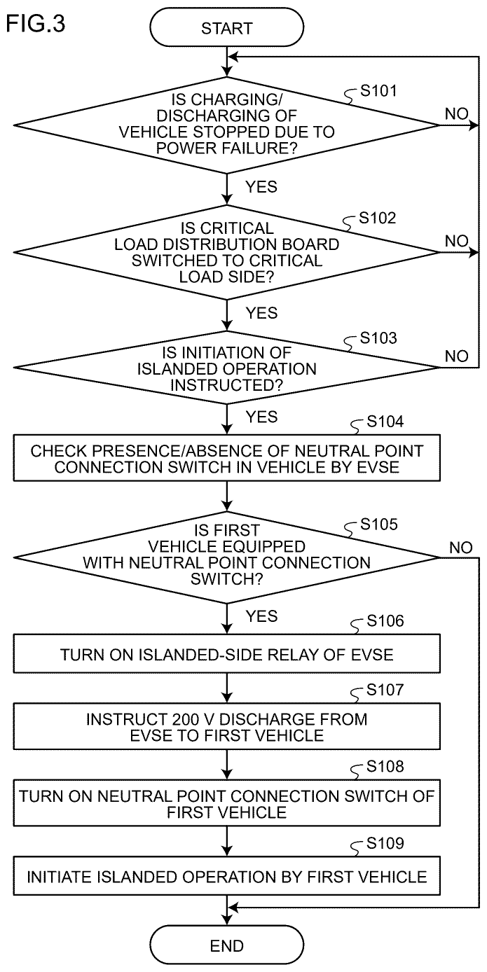

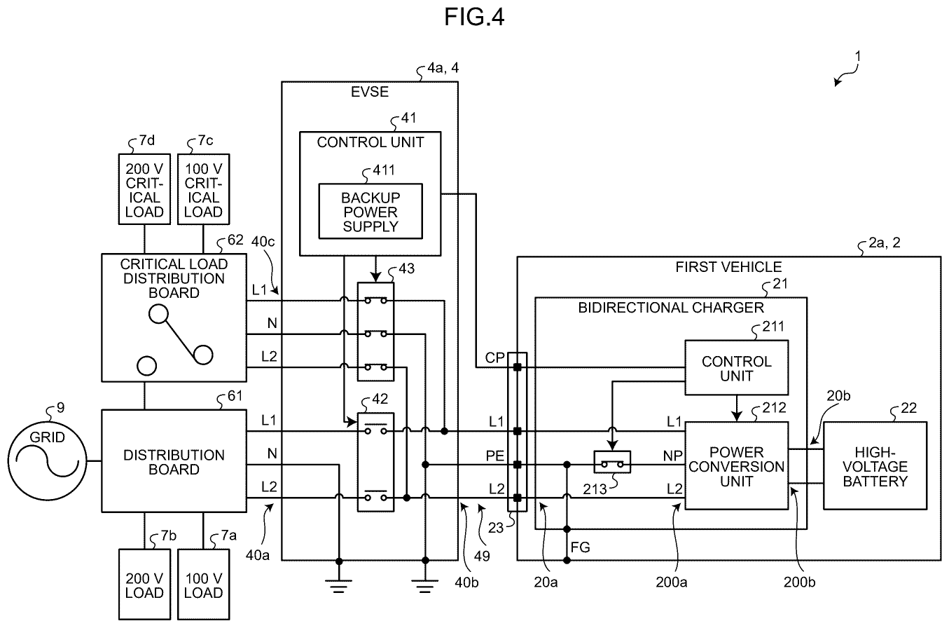

In one example, in a case where islanded operation (see FIGS. 3 and 4) is instructed by a control signal from the external EVSE 4a, the control unit 211 of the first vehicle 2a turns on the neutral point connection switch 213. In other words, in the islanded operation, the control unit 211 of the first vehicle 2a turns on the neutral point connection switch 213 to establish a conductive state between the neutral point NP of the AC-side input/output terminal 200a and the protective earth line PE. In this state, the control unit 211 of the first vehicle 2a causes the power conversion unit 212 to convert the DC power input from the DC-side input/output terminal 200b into AC power and output the AC power from the AC-side input/output terminal 200a.

The control signal instructing the islanded operation from the external EVSE 4a instructs the bidirectional charger 21 to use, as an output voltage value, single-phase 200 V (first voltage), which is the potential difference between a pair of voltage lines L1 and L2 at a grid-side input/output terminal 40a of the EVSE 4a in the grid-connected operation or grid-interconnection operation. In other words, in the islanded operation, the potential difference between the pair of power lines L1 and L2 at the AC-side input/output terminal 200a of the power conversion unit 212 of the first vehicle 2a is single-phase 200 V (first voltage). Thus, in the islanded operation, the potential difference between the pair of power lines L1 and L2 at the AC-side input/output terminal 20a of the bidirectional charger 21 of the first vehicle 2a is single-phase 200 V (first voltage).

Further, in the islanded operation, the neutral point connection switch 213 is turned on. Thus, the AC power output from the power conversion unit 212 is AC power generated based on the neutral point NP. Accordingly, in the islanded operation, the potential difference between each of the pair of power lines L1 and L2 at the AC-side input/output terminal 200a of the power conversion unit 212 of the first vehicle 2a and the neutral point NP of the pair of power lines L1 and L2 at the AC-side input/output terminal 200a is single-phase 100 V (second voltage).

In this way, in the islanded operation, the AC power output from the AC-side input/output terminal 20a of the bidirectional charger 21 of the first vehicle 2a includes single-phase 200 V (first voltage), which is the potential difference between the pair of power lines L1 and L2, and single-phase 100 V (second voltage), which is the potential difference between each of the pair of power lines L1 and L2 and the neutral point NP. In other words, in the islanded operation, the AC power supplied from the bidirectional charger 21 of the first vehicle 2a to the EVSE 4a via a pair of power lines L1 and L2 of the charge/discharge cable 49 is single-phase 200 V (first voltage) AC power from which single-phase 100 V (second voltage) is capable of being extracted relative to the protective earth line PE. Thus, the first vehicle 2a equipped with the neutral point connection switch 213 is capable of appropriately determining the potential of the neutral line N at the consumer receiving power from the single-phase three-wire grid 9 in the islanded operation for supplying power to the consumer. In other words, the islanded operation by the first vehicle 2a equipped with the neutral point connection switch 213 enables both single-phase 100 V device and single-phase 200 V device to be used by the consumer receiving power from the single-phase three-wire grid 9.

The high-voltage battery 22 is electrically connected to the DC-side input/output terminal 200b of the power conversion unit 212 via the DC-side input/output terminal 20b of the bidirectional charger 21. The high-voltage battery 22 stores power supplied from the EVSE 4a via the bidirectional charger 21. The high-voltage battery 22 only needs to be capable of storing power for driving a traveling motor (main drive motor) mounted on the vehicle 2 or for supplying power (discharging) to the external EVSE 4a Any suitable battery, such as a lithium-ion battery, nickel-hydrogen battery, or all-solid-state battery, can be used as the high-voltage battery 22. In this example, the high-voltage battery 22 is an example of an on-board battery and is an example of a battery electrically connected to the DC-side input/output terminal 200b of the power conversion unit 212.

The charge/discharge socket 23 is a power socket mounted on the vehicle 2 for charging and/or discharging. The charge/discharge cable 49 is detachably connected to the charge/discharge socket 23. For example, the bidirectional charger 21 is capable of being connected to external power equipment and/or an external load such as the EVSE 4a via a power socket for charging and discharging that is provided at a position available from outside the vehicle 2. The charge/discharge socket 23 includes a pair of power terminals, a protective earth terminal, and a control terminal.

In both the first vehicle 2a and the second vehicle 2b, the pair of power terminals of the charge/discharge socket 23 are electrically connected to the pair of power lines L1 and L2 of the AC-side input/output terminal 200a of the power conversion unit 212. In addition, the pair of power terminals of the charge/discharge socket 23 are also electrically connected to the pair of power lines L1 and L2 of the charge/discharge cable 49 connected to the vehicle 2.

The protective earth terminal of the charge/discharge socket 23 is electrically connected to the functional grounding line FG at the chassis potential in both the first vehicle 2a and the second vehicle 2b. In addition, the protective earth terminal of the charge/discharge socket 23 is also electrically connected to the protective earth line PE of the charge/discharge cable 49 connected to the vehicle 2.

Further, in the first vehicle 2a, the protective earth terminal of the charge/discharge socket 23 is electrically connected to the neutral point NP of the AC-side input/output terminal 200a of the power conversion unit 212 via the neutral point connection switch 213.

In both the first vehicle 2a and the second vehicle 2b, the control terminal of the charge/discharge socket 23 is electrically connected to the control unit 211. Additionally, the control terminal of the charge/discharge socket 23 is also electrically connected to the control pilot line CP of the charge/discharge cable 49 connected to the vehicle 2. The control terminal of the charge/discharge socket 23 inputs a control signal from the external EVSE 4a via the charge/discharge cable 49.

The EVSE 4a according to the first embodiment is an example of the EVSE 4 according to the present disclosure. The EVSE 4a is a power supply apparatus that is electrically connected to the vehicle 2 via the charge/discharge cable 49. In the EVSE 4a, a vehicle-side input/output terminal 40b is electrically connected to the vehicle 2 via the pair of power lines L1 and L2, the protective earth line PE, and the control pilot line CP of the charge/discharge cable 49. The grid-side input/output terminal 40a of the EVSE 4a is electrically connected to the distribution board 61 via a pair of power lines L1 and L2 and the neutral line N. In the EVSE 4a, an output terminal 40c for islanded operation is electrically connected to the critical load distribution board 62 via a pair of power lines L1 and L2 and a neutral line N.

In the grid-connected operation, the EVSE 4a, which receives AC power from the grid 9 via the distribution board 61, supplies the received AC power to the vehicle 2 via the charge/discharge cable 49. In the grid-interconnection operation, the EVSE 4a supplies the AC power, which is received from the vehicle 2 via the charge/discharge cable 49, to the 100 V load 7a, the 200 V load 7b, the 100 V critical load 7c, and the 200 V critical load 7d via the distribution board 61. In the islanded operation, the EVSE 4a supplies the AC power, which is received from the vehicle 2 via the charge/discharge cable 49, to the 100 V critical load 7c, and the 200 V critical load 7d via the critical load distribution board 62. Moreover, in the grid-interconnection operation, the EVSE 4a may also supply the AC power received from the vehicle 2 via the charge/discharge cable 49 to the grid 9.

As illustrated in FIGS. 1 and 2, the EVSE 4a includes a control unit 41, a grid-side relay 42, and an islanded-side relay 43. In this example, the grid-side relay 42 is an example of a grid-side switch. In addition, the islanded-side relay 43 is an example of an islanded-side switch.

The control unit 41 is an integrated circuit (IC) for control configured to control the operation of each component of the EVSE 4a. The control unit 41 is electrically connected to the control unit 211 of the vehicle 2 via the control pilot line CP of the charge/discharge cable 49. The control unit 41 communicates with the control unit 211 of the vehicle 2. Additionally, the control unit 41 is also electrically connected to the grid-side relay 42 and the islanded-side relay 43 via a control line. The control unit 41 controls the operation of each of the grid-side relay 42 and the islanded-side relay 43. In this example, the control unit 41 of the EVSE 4a is an example of a second control unit (second controller).

In one example, the control unit 41 controls the grid-connected operation. In the grid-connected operation, in a case where the vehicle 2 is connected via the charge/discharge cable 49, the control unit 41 turns on the grid-side relay 42 to establish electrical conduction between the distribution board 61 and the charge/discharge cable 49. Additionally, in this state, the control unit 41 supplies the AC power, which is supplied from the grid 9 via the distribution board 61, to the vehicle 2 to which the charge/discharge cable 49 is connected.

In one example, the control unit 41 controls the grid-interconnection operation. In the grid-interconnection operation, in a case where the vehicle 2 is connected via the charge/discharge cable 49, the control unit 41 turns on the grid-side relay 42 to establish electrical conduction between the distribution board 61 and the charge/discharge cable 49. Additionally, in this state, the control unit 41 supplies the AC power, which is supplied from the vehicle 2 via the charge/discharge cable 49, to the distribution board 61.

In one example, in a case where a power failure of the grid 9 is detected, the control unit 41 controls the islanded operation performed by the vehicle 2. In the islanded operation, in a case where a power failure of the grid 9 is detected, the control unit 41 checks whether the vehicle 2 connected via the charge/discharge cable 49 is provided with the neutral point connection switch 213.

For example, if the vehicle 2 connected via the charge/discharge cable 49 is the first vehicle 2a equipped with the neutral point connection switch 213, the control unit 41 turns on the islanded-side relay 43 to establish electrical conduction between the critical load distribution board 62 and the charge/discharge cable 49. Additionally, in this state, the control unit 41 outputs a control signal instructing the islanded operation to the control unit 211 of the bidirectional charger 21 installed in the first vehicle 2a connected via the charge/discharge cable 49. The control unit 41 then supplies the AC power, which is supplied from the first vehicle 2a via the charge/discharge cable 49, to the critical load distribution board 62.

For example, if the vehicle 2 connected via the charge/discharge cable 49 is the second vehicle 2b not equipped with the neutral point connection switch 213, the control unit 41 does not output a control signal instructing the islanded operation. In other words, the control unit 41 does not allow the islanded operation if the vehicle 2 connected via the charge/discharge cable 49 is not equipped with the neutral point connection switch 213.

Further, the control unit 41 includes a backup power supply 411. In a case where the power supply from the grid 9 is stopped, such as during a power failure of the grid 9, the control unit 41 is capable of operating using power from the backup power supply 411.

The grid-side relay 42 is provided between the grid-side input/output terminal 40a of the EVSE 4a and the vehicle-side input/output terminal 40b. In other words, the grid-side relay 42 is provided between the distribution board 61 and the charge/discharge cable 49. The grid-side relay 42 switches between conduction and disconnection between the distribution board 61 and the charge/discharge cable 49. Specifically, the grid-side relay 42 switches between conduction and disconnection between the power line L1 (voltage line) of the grid-side input/output terminal 40a and the power line L1 of the vehicle-side input/output terminal 40b. In addition, the grid-side relay 42 switches between conduction and disconnection between the power line L2 (voltage line) of the grid-side input/output terminal 40a and the power line L2 of the vehicle-side input/output terminal 40b. Moreover, the neutral line N of the grid-side input/output terminal 40a of the EVSE 4a and the protective earth line PE of the vehicle-side input/output terminal 40b are electrically connected to a grounding line at ground potential.

The islanded-side relay 43 is provided between the output terminal 40c for islanded operation of the EVSE 4a and the vehicle-side input/output terminal 40b. In other words, the islanded-side relay 43 is provided between the critical load distribution board 62 and the charge/discharge cable 49. The islanded-side relay 43 switches between conduction and disconnection between the critical load distribution board 62 and the charge/discharge cable 49. Specifically, the islanded-side relay 43 switches between conduction and disconnection between the power line L1 (voltage line) of the output terminal 40c for islanded operation and the power line L1 of the vehicle-side input/output terminal 40b. In addition, the islanded-side relay 43 switches between conduction and disconnection between the power line L2 (voltage line) of the output terminal 40c for islanded operation and the power line L2 of the vehicle-side input/output terminal 40b. Additionally, the islanded-side relay 43 switches between conduction and disconnection between the neutral line N of the output terminal 40c for islanded operation and the protective earth line PE (and the grounding line at ground potential) of the vehicle-side input/output terminal 40b.

The distribution board 61 is provided between the grid 9 and the EVSE 4a. At least one load is capable of being electrically connected to the distribution board 61. The loads electrically connected to the distribution board 61 are capable of operating using AC power supplied from the distribution board 61. FIGS. 1 and 2 illustrate the 100 V load 7a and the 200 V load 7b as examples of at least one load. The 100 V load 7a is an electric power device that operates using single-phase 100 V AC power from the distribution board 61. The 200 V load 7b is an electric power device that operates using single-phase 200 V AC power from the distribution board 61. In one example, AC power from the distribution board 61 can be supplied to each load in a house (consumer) via an outlet inside the house. In this example, the distribution board 61 is an example of a first distribution board.

The critical load distribution board 62 is provided between the distribution board 61 and the EVSE 4a. In other words, the critical load distribution board 62 is electrically connected to the grid 9 via the distribution board 61. At least one critical load can be electrically connected to the critical load distribution board 62. In this example, the critical load refers to a load to which power is supplied from the vehicle 2 via the EVSE 4a and the critical load distribution board 62 in a state where power supply from the grid 9 is stopped, such as during a power failure. The load electrically connected to the critical load distribution board 62 is capable of operating using AC power supplied from the critical load distribution board 62. FIGS. 1 and 2 illustrate the 100 V critical load 7c and the 200 V critical load 7d as examples of at least one critical load. The 100 V critical load 7c is an electric power device that operates using single-phase 100 V AC power from the critical load distribution board 62. The 200 V critical load 7d is an electric power device that operates using single-phase 200 V AC power from the critical load distribution board 62. In one example, the AC power from the critical load distribution board 62 can be supplied to each critical load in a house (consumer) via an outlet within the house. In this example, the critical load distribution board 62 is an example of a second distribution board.

Moreover, the critical load distribution board 62 is capable of switching the AC power supplied to the critical load between the AC power from the distribution board 61 and the AC power from the EVSE 4a. This switching is performed, for example, by user operation, but may also be performed automatically in a case where the critical load distribution board 62 detects a power failure of the grid 9, or in response to a control signal from the EVSE 4a, or in response to a control signal from a home energy management system (HEMS) that controls, monitors, and manages each of the consumer's power facilities and power devices.

Moreover, each the control unit 211 of the bidirectional charger 21 and the control unit 41 of the EVSE 4a includes, for example, at least one processor (not illustrated) and at least one memory (not illustrated), and has a hardware configuration using a conventional computer. Each of the control units 211 and 41 can be implemented using, for example, a digital signal processor (DSP). Alternatively, each of the control units 211 and 41 may implement respective functions by, for example, a processor such as a central processing unit (CPU) executing a program stored in an auxiliary storage device such as a read-only memory (ROM), the program being loaded into a main storage device such as a random-access memory (RAM), or may implement the respective functions by dedicated hardware circuits (such as semiconductor integrated circuits).

Moreover, the control unit 211 may also be implemented by, for example, an electronic control unit (ECU) provided inside the vehicle 2, a domain control unit (DCU) such as a cockpit domain controller (CDC) that integrates a plurality of ECUs, or an on-board unit (OBU), all of which are computers. In addition, the control unit 211 may also transmit and receive information to and from other ECUs installed in the vehicle 2 or external devices (e.g., the EVSE 4a) connected to the vehicle 2 via an in-vehicle network, such as a controller area network (CAN), Ethernet (registered trademark), or universal serial bus (USB; registered trademark) within the vehicle 2, or may communicate with information processing devices external to the vehicle 2 via a network such as the Internet.

Next, an exemplary operation of the power system 1 configured as described above will be described.

FIG. 3 is a flowchart illustrating an exemplary operation of the power system 1 according to the first embodiment in the islanded operation. FIG. 4 is a diagram illustrating an example of the connection state in the islanded operation in a case where the first vehicle 2a is connected to the power system 1 according to the first embodiment.

In the flow illustrated in FIG. 3, if charging and discharging of the vehicle 2 is not stopped due to a power failure or the like (S101: No), the system waits in a standby state. On the other hand, if the power supply from the grid 9 is stopped due to a power failure or the like, charging and discharging of the vehicle 2 is stopped (S101: Yes), and then the process proceeds to step S102.

Moreover, the control unit 41 of the EVSE 4a may detect whether the power supply from the grid 9 is stopped due to a power failure or the like based on a measurement result of a voltage sensor that is provided to be capable of measuring the potential difference between a pair of power lines L1 and L2 (a pair of voltage lines) at the grid-side input/output terminal 40a. Alternatively, the control unit 41 of the EVSE 4a may detect whether the power supply from the grid 9 is stopped due to a power failure or the like based on a notification (control signal) from the HEMS. Alternatively, the control unit 211 of the vehicle 2 may detect whether the power supply from the grid 9 is stopped due to a power failure or the like based on a measurement result of a voltage sensor that is provided to be capable of measuring a potential difference between the pair of power lines L1 and L2 of the power conversion unit 212. Furthermore, whether charging and discharging of the vehicle 2 is stopped may be determined based on an input result to the EVSE 4a or HEMS by a user, or based on a notification (control signal) from the vehicle 2 to the EVSE 4a or the HEMS.

In the flow illustrated in FIG. 3, if charging and discharging of the vehicle 2 is stopped due to a power failure or the like and the critical load distribution board 62 is not switched to the critical load side (S102: No), the process returns to step S101. On the other hand, as illustrated in FIG. 4, if charging and discharging of the vehicle 2 is stopped due to a power failure or the like and the critical load distribution board 62 is switched to the critical load side (S102: Yes), the process proceeds to step S103.

Moreover, the control unit 41 of the EVSE 4a may determine whether the critical load distribution board 62 is switched to the critical load side based on the user's input to the EVSE 4a or the HEMS, or based on a notification (control signal) from the critical load distribution board 62 or the HEMS to the EVSE 4a.

In the flow of FIG. 3, if charging and discharging of the vehicle 2 is stopped due to a power failure or the like, the critical load distribution board 62 is switched to the critical load side, and the initiation of the islanded operation is not instructed (S103: No), the process returns to step S101. On the other hand, if charging and discharging of the vehicle 2 is stopped due to a power failure or the like, the critical load distribution board 62 is switched to the critical load side, and the initiation of the islanded operation is instructed (S103: Yes), the process proceeds to step S104.

Moreover, the control unit 41 of the EVSE 4a may determine whether an instruction to initiate the islanded operation is issued based on the user's input to the EVSE 4a or the HEMS, or based on a notification (control signal) sent to the EVSE 4a from the critical load distribution board 62 or the HEMS. Moreover, in a configuration in which the critical load distribution board 62 automatically switches to the critical load side upon detection of a power failure, the control unit 41 of the EVSE 4a may determine that an instruction to initiate the islanded operation is issued upon detection of a power failure or the like.

In a case where the islanded operation is to be initiated, the control unit 41 of the EVSE 4a checks whether the neutral point connection switch 213 is present in the vehicle 2 connected via the charge/discharge cable 49 (S104).

Moreover, the control unit 41 of the EVSE 4a may determine the presence or absence of the neutral point connection switch 213 based on information (control signal) indicating the presence or absence of the neutral point connection switch 213 received from the vehicle 2 via the control pilot line CP. Alternatively, the control unit 41 of the EVSE 4a may determine the presence or absence of the neutral point connection switch 213 based on information (control signal) indicating the type of the vehicle 2 received from the vehicle 2 via the control pilot line CP and information indicating the correspondence between the type of the vehicle 2 and the presence or absence of the neutral point connection switch 213, the correspondence being stored in an internal memory in advance. Alternatively, the control unit 41 of the EVSE 4a may determine the presence or absence of the neutral point connection switch 213 based on a result of input (or pre-registration result) made by the user to the EVSE 4a or the HEMS. Moreover, the presence or absence of the neutral point connection switch 213 may be checked in advance, for example, at the time of connection of the charge/discharge cable 49, and the check result may be stored in the internal memory.

As illustrated in FIG. 4, in the case of the first vehicle 2a equipped with the neutral point connection switch 213 (S105: Yes), the control unit 41 of the EVSE 4a confirms that the grid-side relay 42 of the EVSE 4a is in the off state (because the relay is turned off in a case where a power failure is detected, i.e., at the time of S101: Yes), and turns on the islanded-side relay 43 (S106). Then, the control unit 41 of the EVSE 4a transmits a control signal to the control unit 211 of the bidirectional charger 21 of the first vehicle 2a to instruct discharge at single-phase 200 V (first voltage), i.e., a control signal instructing the islanded operation (S107).

The control unit 211 of the first vehicle 2a, which receives the control signal instructing the islanded operation from the EVSE 4a, turns on the neutral point connection switch 213 (S108), controls the power conversion of the power conversion unit 212 to generate single-phase 200 V (first voltage), and initiates the islanded operation to supply power to the EVSE 4a (S109). Then, the flow in FIG. 3 ends.

On the other hand, if the vehicle 2 is not the first vehicle 2a equipped with the neutral point connection switch 213, i.e., the second vehicle 2b (S105: No), the flow in FIG. 3 ends. In other words, if the second vehicle 2b, which is not equipped with the neutral point connection switch 213, is connected, the control unit 41 of the EVSE 4a does not allow the islanded operation and stops the processing for islanded operation.

Moreover, the control unit 41 of the EVSE 4a may also determine the end of the islanded operation based on a result of user input to the EVSE 4a or HEMS or detection of power supply from the grid 9 (restoration from a power failure). At the end of the islanded operation, the control unit 41 of the EVSE 4a transmits a control signal instructing the end of the islanded operation to the control unit 211 of the vehicle 2. In addition, upon receiving the transmitted control signal, the control unit 211 of the vehicle 2 stops operation of the power conversion unit 212 and turns off the neutral point connection switch 213. Thereafter, the control unit 41 of the EVSE 4a turns off the islanded-side relay 43 of the EVSE 4a and turns on the grid-side relay 42. Then, the critical load distribution board 62 is switched to the normal load side (see FIGS. 1 and 2). Moreover, the switching of the critical load distribution board 62 may be performed before the control signal instructing the end of the islanded operation is transmitted from the control unit 41 of the EVSE 4a to the control unit 211 of the vehicle 2. Furthermore, the control unit 41 of the EVSE 4a may also determine the end of the islanded operation based on the switching of the critical load distribution board 62.

As described above, the power system 1 according to the present embodiment enables the islanded operation by the vehicle 2 in a case where the first vehicle 2a equipped with the neutral point connection switch 213 is connected. In the islanded operation, the neutral point connection switch 213 is turned on to establish electrical conduction between the neutral point NP of the AC-side input/output terminal 200a of the power conversion unit 212 and the protective earth line PE of the charge/discharge cable 49, which is functionally grounded to the chassis potential.

Conventionally, a charging connector of the vehicle 2 for single-phase 200 V does not have an N-phase terminal, and thus in the islanded operation by the vehicle 2 connected to a consumer such as a house via the EVSE 4a for single-phase 200 V, both a single-phase 200 V device and a single-phase 100 V device could not be made available. Additionally, if the neutral point NP of the power conversion unit 212 of the on-board bidirectional charger 21 is configured to be connected to the chassis potential of the vehicle 2, the neutral point NP of the power conversion unit 212 and the N phase of the single-phase three-wire system on the EVSE 4a side can be set to the same potential, but such a configuration posed a problem in that the on-board bidirectional charger 21 would violate standards during single-phase 200 V charging.

In this situation, the above-described configuration according to the present embodiment enables single-phase 200 V (first voltage) AC power to be generated between the pair of power lines L1 and L2 of the AC-side input/output terminal 200a of the power conversion unit 212 of the vehicle 2, with the chassis potential as a reference. Furthermore, in the EVSE 4a to which the relevant AC power is supplied, it is possible to extract both single-phase 200 V (first voltage) AC power and single-phase 100 V (second voltage) AC power, with the potential of the protective earth line PE electrically connected to the neutral point NP of the power conversion unit 212 as a reference.

Thus, the power system 1 according to the present embodiment enables the neutral line potential at a consumer receiving power supply from a single-phase three-wire power grid to be appropriately determined for power supply from the on-board charger to the consumer. In other words, the power system 1 according to the present embodiment enables the use of both single-phase 100 V and 200 V devices in the islanded operation of a vehicle. Furthermore, in other modes including single-phase 200 V charging, since the neutral point connection switch 213 is turned off, neither the power lines L1 and L2 nor the neutral line NP of the power conversion unit 212 are functionally grounded to the chassis potential, thereby achieving a configuration that complies with standards.

The following describes modifications and other embodiments of the present disclosure. Note that the following descriptions of modifications and embodiments will mainly focus on differences, and redundant description overlapping with the foregoing description will be omitted as appropriate.

### Modification

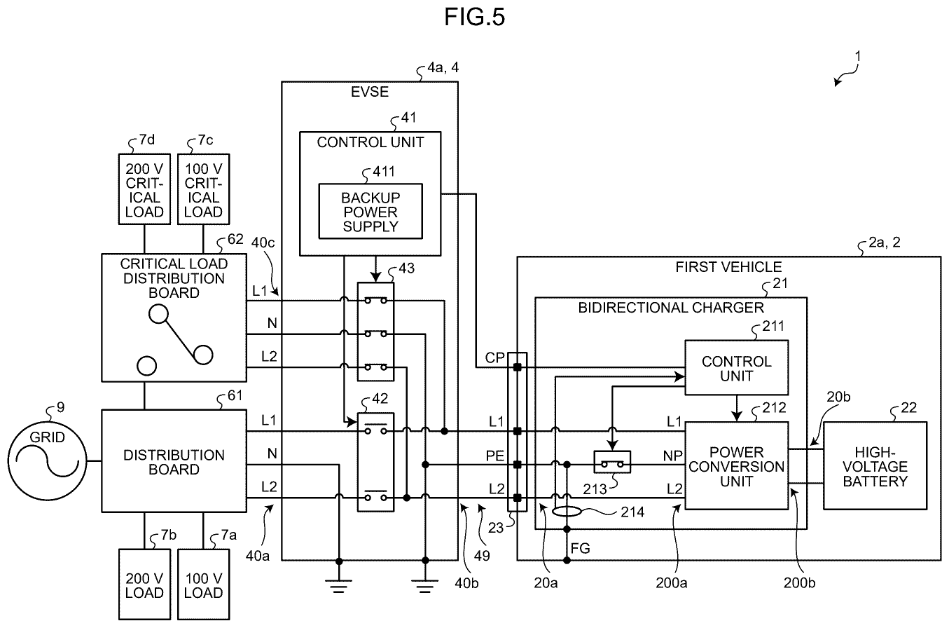

FIG. 5 is a diagram illustrating an exemplary configuration of a power system 1 according to a modification of the first embodiment. FIG. 5 exemplifies a connection state during the islanded operation in a case where a first vehicle 2a is connected to the power system 1 according to the present modification.

As illustrated in FIG. 5, in the power system 1 according to the present modification, a bidirectional charger 21 of the first vehicle 2a further includes a current sensor 214.

In the bidirectional charger 21, the current sensor 214 is provided in series with the functional grounding line FG at a chassis potential. In other words, the current sensor 214 is provided between the functional grounding line FG at the chassis potential and the side of the protective earth line PE of the neutral point connection switch 213. In other words, the current sensor 214 detects current (insulation failure) flowing through the functional grounding line FG at the chassis potential.

In the bidirectional charger 21, the control unit 211 determines that the islanded operation is to be stopped in a case where, with the neutral point connection switch 213 turned on, the current sensor 214 detects a current greater than or equal to a predetermined threshold value stored in an internal memory. If it is determined that the islanded operation is to be stopped, the control unit 211 stops power conversion by the power conversion unit 212 and also turns off the neutral point connection switch 213.

As described above, in the power system 1 according to the present modification, the bidirectional charger 21 of the first vehicle 2a is provided with the current sensor 214 configured to detect insulation failure between the neutral point connection switch 213 and the functional grounding line FG at the chassis potential. This configuration enables insulation failure detection and improves safety in the islanded operation by the first vehicle 2a.

### Second Embodiment

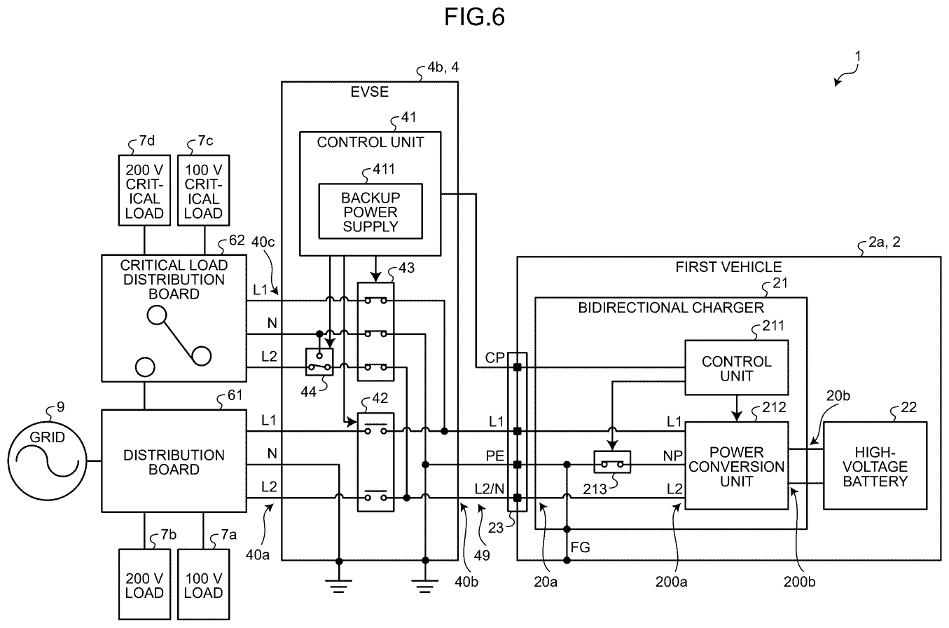

FIG. 6 is a diagram illustrating an exemplary configuration of a power system 1 according to a second embodiment. FIG. 6 illustrates an example of the connection state during the islanded operation in a case where a first vehicle 2a is connected to the power system 1 according to the second embodiment.

An EVSE 4b according to the second embodiment is a power supply apparatus which, in a case where the islanded operation is determined to be performed, switches the connection with the consumer side between a single-phase three-wire 200 V system and a single-phase 100 V system depending on the presence or absence of a neutral point connection switch 213. In other words, the EVSE 4b according to the second embodiment is a power supply apparatus that instructs an output voltage value depending on the presence or absence of the neutral point connection switch 213. The EVSE 4b according to the second embodiment is an example of the EVSE 4 according to the present disclosure.

As illustrated in FIG. 6, the EVSE 4b according to the present embodiment further includes an LN short-circuit switch 44.

The LN short-circuit switch 44 is provided between an islanded-side output terminal 40c and an islanded-side relay 43, or between the islanded-side relay 43 and a vehicle-side input/output terminal 40b. FIG. 6 illustrates an example of the LN short-circuit switch 44 provided between the islanded-side output terminal 40c and the islanded-side relay 43. The LN short-circuit switch 44 is a short-circuit switch that electrically connects one of a pair of power lines L1 and L2 of a charge/discharge cable 49 to either one of a pair of power lines L1 and L2 (pair of voltage lines) of the corresponding islanded-side output terminal 40c, or to a neutral line N of the islanded-side output terminal 40c, via the islanded-side relay 43.

The example in FIG. 6 illustrates the LN short-circuit switch 44 that electrically connects the power line L2 of the charge/discharge cable 49 to either the power line L2 (voltage line) of the islanded-side output terminal 40c or to the neutral line N, via the islanded-side relay 43.

The EVSE 4b includes a control unit 41 electrically connected to a grid-side relay 42, the islanded-side relay 43, and the LN short-circuit switch 44 via a control line. The control unit 41 controls the operation of the grid-side relay 42, the islanded-side relay 43, and the LN short-circuit switch 44. In this example, the control unit 41 of the EVSE 4b is an example of a second control unit.

In one example, the control unit 41 of the EVSE 4b controls grid-connected operation. In the grid-connected operation, in a case where the vehicle 2 is connected via the charge/discharge cable 49, the control unit 41 turns on the grid-side relay 42 to establish electrical conduction between the distribution board 61 and the charge/discharge cable 49. Further, in this state, the control unit 41 supplies single-phase 200 V (first voltage) AC power supplied from the grid 9 via the distribution board 61 to the vehicle 2 connected via the charge/discharge cable 49. In other words, in the grid-connected operation, for each of the vehicles 2, i.e., the first vehicle 2a and a second vehicle 2b, the potential difference between the pair of power lines L1 and L2 of an AC-side input/output terminal 20a of a bidirectional charger 21 is single-phase 200 V (first voltage).

In one example, the control unit 41 of the EVSE 4b controls grid-interconnection operation. In the grid-interconnection operation, in a case where the vehicle 2 is connected via the charge/discharge cable 49, the control unit 41 turns on the grid-side relay 42 to establish electrical conduction between the distribution board 61 and the charge/discharge cable 49. In this state, the control unit 41 supplies single-phase 200 V (first voltage) AC power supplied from the vehicle 2 via the charge/discharge cable 49 to the distribution board 61. In other words, in the grid-interconnection operation, for each of the vehicles 2, i.e., the first vehicle 2a and the second vehicle 2b, the potential difference between the pair of power lines L1 and L2 of the AC-side input/output terminals 20a of the bidirectional charger 21 is single-phase 200 V (first voltage).

In one example, in a case where a power failure of the grid 9 is detected, the control unit 41 of the EVSE 4b controls the islanded operation of the vehicle 2.

In one example, in the islanded operation, if a power failure of the grid 9 is detected, the control unit 41 of the EVSE 4b checks the presence or absence of the neutral point connection switch 213 in the vehicle 2 connected via the charge/discharge cable 49.

In one example, in the islanded operation, the control unit 41 turns on the islanded-side relay 43 to establish electrical conduction between a critical load distribution board 62 and the charge/discharge cable 49. Further, in this state, the control unit 41 outputs a control signal instructing the islanded operation to the control unit 211 of the bidirectional charger 21 mounted on the vehicle 2 connected via the charge/discharge cable 49. Then, the control unit 41 supplies AC power, the voltage of which depends on the presence or absence of the neutral point connection switch 213 and which is supplied from the vehicle 2 via the charge/discharge cable 49, to the critical load distribution board 62.

In one example, the control signal instructing the islanded operation specifies an output voltage value depending on the presence or absence of the neutral point connection switch 213.

For example, if the vehicle 2 connected via the charge/discharge cable 49 is the first vehicle 2a and has a neutral point connection switch 213, the control signal specifies single-phase 200 V (first voltage) as the output voltage value. The single-phase 200 V (first voltage) mentioned above is the potential difference between the pair of power lines L1 and L2 (pair of voltage lines) at the grid-side input/output terminals 40a in the grid-connected operation or the grid-interconnection operation. In other words, in the islanded operation, the potential difference between the pair of power lines L1 and L2 of the AC-side input/output terminals 20a of the bidirectional charger 21 of the first vehicle 2a is single-phase 200 V (first voltage). Furthermore, in the islanded operation, the potential difference between each of the pair of power lines L1 and L2 of the AC-side input/output terminals 20a of the bidirectional charger 21 of the first vehicle 2a and a neutral point NP is single-phase 100 V (second voltage).

For example, if the vehicle 2 connected via the charge/discharge cable 49 is the second vehicle 2b and does not have the neutral point connection switch 213, the control signal specifies single-phase 100 V (second voltage) as the output voltage. The single-phase 100 V (second voltage) is the potential difference between the neutral line N and each of the pair of power lines L1 and L2 (pair of voltage lines) at the grid-side input/output terminal 40a in the grid-connected operation or the grid-interconnection operation. In other words, in the islanded operation, the potential difference between the pair of power lines L1 and L2 of the AC-side input/output terminal 20a of the bidirectional charger 21 of the second vehicle 2b is single-phase 100 V (second voltage).

In one example, in the islanded operation, the control unit 41 of the EVSE 4b turns off the LN short-circuit switch 44 in a case where the vehicle 2 connected via the charge/discharge cable 49 is the first vehicle 2a and has the neutral point connection switch 213. Then, the control unit 41 outputs a control signal instructing the islanded operation in a state in which one of the pair of power lines L1 and L2 of the charge/discharge cable 49 is electrically connected to a corresponding one of the pair of power lines L1 and L2 (pair of voltage lines) of the islanded-side output terminal 40c, i.e., in a state in which the power lines L1 are electrically connected to each other or the power lines L2 are electrically connected to each other.

In one example, in the islanded operation, the control unit 41 of the EVSE 4b turns on the LN short-circuit switch 44 in a case where the vehicle 2 connected via the charge/discharge cable 49 is the second vehicle 2b that does not have a neutral point connection switch 213. Then, the control unit 41 outputs a control signal instructing the islanded operation in a state in which one of the pair of power lines L1 and L2 of the charge/discharge cable 49 is electrically connected to the neutral line N of the islanded-side output terminal 40c.

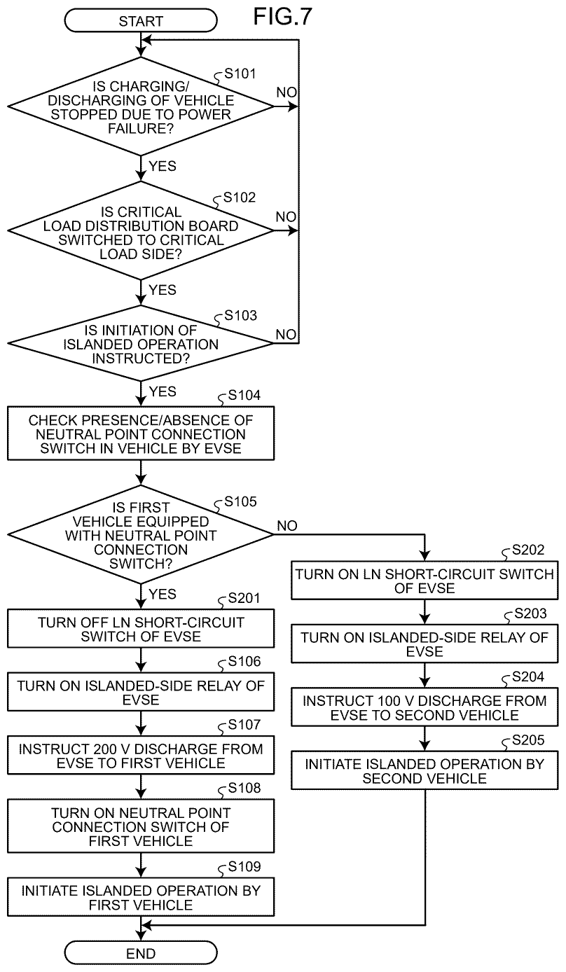

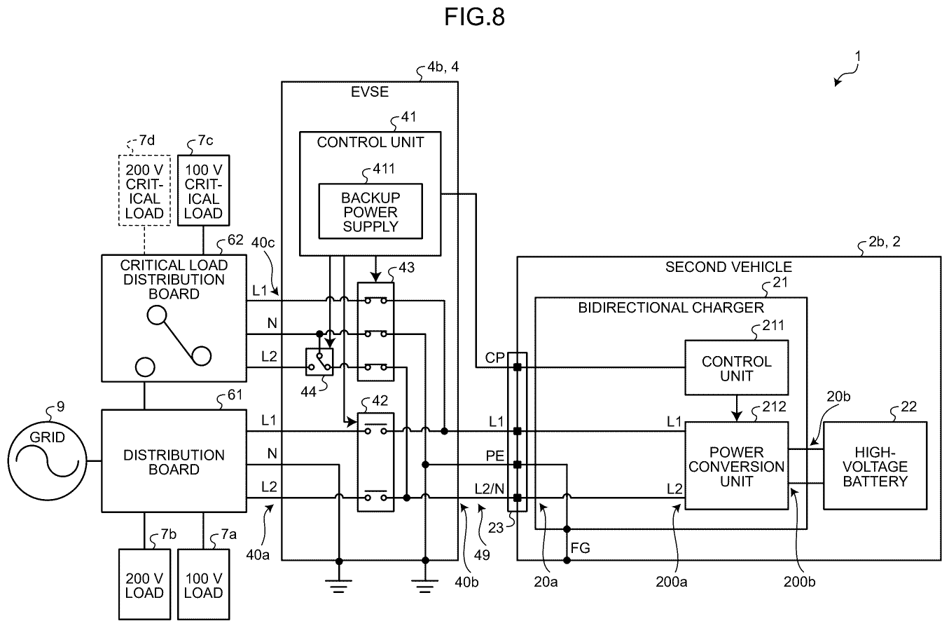

FIG. 7 is a flowchart illustrating an exemplary operation of the power system 1 according to the second embodiment in the islanded operation. FIG. 8 is a diagram illustrating an example of the connection state in the islanded operation in a case where the second vehicle 2b is connected to the power system 1 according to the second embodiment.

In the case of the first vehicle 2a equipped with the neutral point connection switch 213 (S105: Yes), as illustrated in FIG. 6, the control unit 41 of the EVSE 4b turns off the LN short-circuit switch 44 to connect the corresponding power line (power line L2 in FIG. 6) (S201), confirms that the grid-side relay 42 is in an off state, and turns on the islanded-side relay 43 (S106). Steps S107 to S109 are similar to those in FIG. 3, so their descriptions are omitted herein.

On the other hand, if the connected vehicle 2 is not the first vehicle 2a equipped with the neutral point connection switch 213, i.e., in the case of the second vehicle 2b (S105: No), the control unit 41 of the EVSE 4b turns on the LN short-circuit switch 44 to short-circuit one of the power lines (power line L2 in FIG. 8) to the neutral line N (S202), as illustrated in FIG. 8, confirms that the grid-side relay 42 is in an off state, and turns on the islanded-side relay 43 (S203). Then, the control unit 41 of the EVSE 4b transmits a control signal instructing discharge at single-phase 100 V (second voltage), namely a control signal instructing the islanded operation, to the control unit 211 of the bidirectional charger 21 of the second vehicle 2b (S204).

The control unit 211 of the second vehicle 2b, upon receiving a control signal from the EVSE 4b instructing the second vehicle 2b to perform the islanded operation, controls the power conversion of the power conversion unit 212 to generate single-phase 100 V (second voltage) and supplies the generated power to the EVSE 4b, thereby initiating the islanded operation (S205). Then, the flow of FIG. 7 ends.

In this way, in the islanded operation, the EVSE 4b according to the second embodiment instructs the vehicle 2 to operate at an output voltage value that depends on whether the neutral point connection switch 213 is present or absent. Specifically, in a case where the first vehicle 2a equipped with the neutral point connection switch 213 is connected, the EVSE 4b instructs the vehicle 2 to operate at an output voltage value of single-phase 200 V with the power line L2 and the neutral line N not being short-circuited by the LN short-circuit switch 44, and in a case where the second vehicle 2b not equipped with a neutral point connection switch 213 is connected, the EVSE 4b instructs the vehicle 2 to operate at an output voltage value of single-phase 100 V with the power line L2 and the neutral line N being short-circuited.

With this configuration, in the EVSE 4b connected to the single-phase three-wire 200 V (L1 and L2) of the grid 9 and in the on-board bidirectional charger 21, in a case where it is determined that the islanded operation is to be performed, the EVSE 4b switches the connection with the consumer side from the single-phase three-wire 200 V system to the single-phase 100 V system. Then, the EVSE 4b issues a command to the bidirectional charger 21 to operate the islanded operation at single-phase 100 V. In addition, the EVSE 4b supplies the single-phase 100 V output from the bidirectional charger 21 upon receiving the command to a 100 V critical load 7c connected to the critical load distribution board 62. In other words, this configuration enables both single-phase 200 V charging (grid-connected operation) and islanded operation, which allows the use of at least 100 V devices.

### Third Embodiment

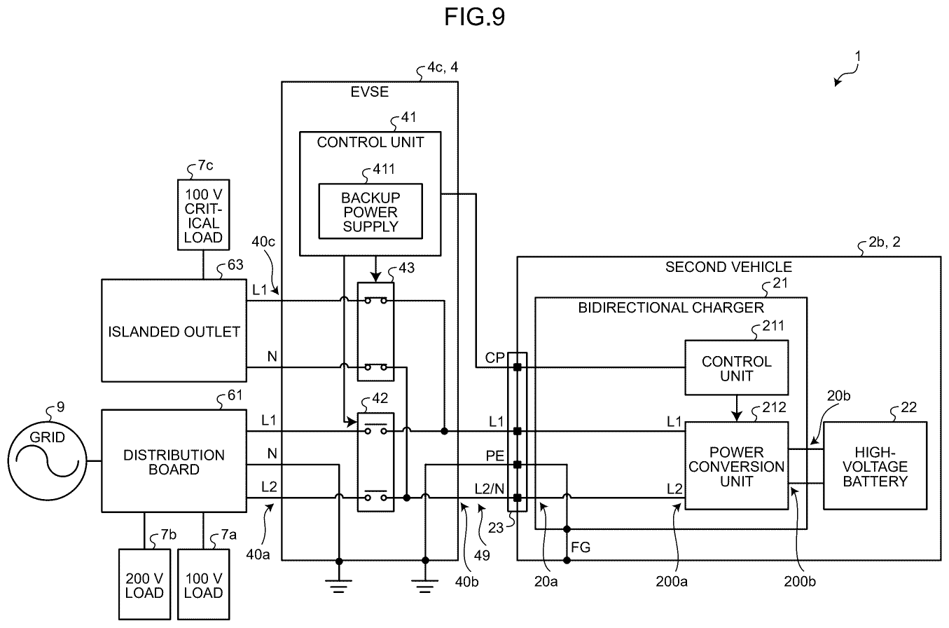

FIG. 9 is a diagram illustrating an exemplary configuration of a power system 1 according to a third embodiment. FIG. 9 illustrates an example of a connection state in the islanded operation in a case where a second vehicle 2b is connected to the power system 1 according to the third embodiment.

An EVSE 4c according to the third embodiment is a power supply apparatus that, irrespective of the presence or absence of the neutral point connection switch 213, switches the connection with the consumer side from a single-phase three-wire 200 V system for grid-connected operation or grid-interconnection operation to a single-phase 100 V system for islanded operation in a case where it is determined that the islanded operation is to be performed. The EVSE 4c according to the third embodiment is an example of the EVSE 4 according to the present disclosure.

As illustrated in FIG. 9, the power system 1 according to the present embodiment includes an islanded outlet 63 instead of the critical load distribution board 62. In this example, the islanded outlet 63 is an example of the second distribution board.

The islanded outlet 63 is electrically connected to the EVSE 4c but, unlike the critical load distribution board 62, the islanded outlet 63 is not connected to a distribution board 61. The islanded outlet 63 is capable of being electrically connected with at least one critical load. Moreover, the critical load connected to the islanded outlet 63 includes a 100 V critical load 7c, but not a 200 V critical load 7d. In other words, the islanded outlet 63 supplies AC power from the EVSE 4c to the 100 V critical load 7c.

In the EVSE 4c, an islanded-side relay 43 is provided between an output terminal 40c for islanded operation of the EVSE 4c and a vehicle-side input/output terminal 40b. In other words, the islanded-side relay 43 is provided between the islanded outlet 63 and a charge/discharge cable 49. The islanded-side relay 43 switches between conduction and disconnection between the islanded outlet 63 and the charge/discharge cable 49. Specifically, the islanded-side relay 43 switches between conduction and disconnection between the power line L1 (voltage line) of the output terminal 40c for islanded operation and the power line L1 of the vehicle-side input/output terminal 40b. Additionally, the islanded-side relay 43 switches between conduction and disconnection between a neutral line N of the output terminal 40c for islanded operation and a power line L2 of the vehicle-side input/output terminal 40b.

Thus, in the grid-connected operation or the grid-interconnection operation, the EVSE 4c according to the present embodiment electrically connects a pair of power lines L1 and L2 on the vehicle 2 side to a pair of power lines L1 and L2 (pair of voltage lines) on the grid 9 side. Additionally, in the islanded operation, the EVSE 4c electrically connects one of the pair of power lines L1 and L2 on the vehicle 2 side to one of the corresponding pair of power lines L1 and L2 (pair of voltage lines) on the 100 V critical load 7c side, and electrically connects the other to the neutral line N. This configuration enables the EVSE 4c according to the present embodiment to establish electrical connection with the consumer side via a single-phase three-wire 200 V system during the grid-connected operation or the grid-interconnection operation, and via a single-phase 100 V system during the islanded operation.

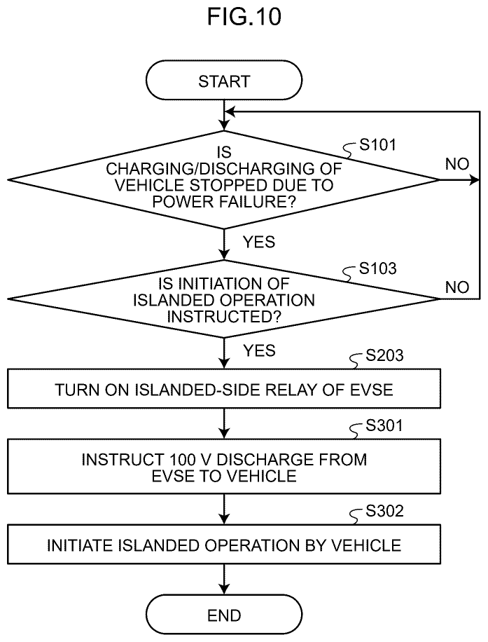

FIG. 10 is a flowchart illustrating an exemplary operation of the power system 1 according to the third embodiment in the islanded operation.

If the power supply from the grid 9 is stopped due to a power failure or other reason, charging and discharging of the vehicle 2 are stopped (S101: Yes), and then the process proceeds to step S103.

In the flow in FIG. 10, in a case where the charging and discharging of the vehicle 2 are stopped due to a power failure or the like and an instruction to initiate the islanded operation is not issued (S103: No), the process returns to step S101. On the other hand, if charging and discharging of the vehicle 2 are stopped due to a power failure or the like and an instruction to initiate the islanded operation is issued (S103: Yes), the process proceeds to step S203.

In a case where the islanded operation is to be initiated, the control unit 41 of the EVSE 4c, as illustrated in FIG. 9, confirms that the grid-side relay 42 is in an off state and turns on the islanded-side relay 43 (S203). Then, the control unit 41 of the EVSE 4c transmits a control signal instructing discharge at single-phase 100 V (second voltage), i.e., a control signal instructing the islanded operation, to the control unit 211 of the bidirectional charger 21 of the first vehicle 2a or the second vehicle 2b connected via the charge/discharge cable 49 (S301).

The control unit 211 of the first vehicle 2a or the second vehicle 2b, upon receiving the control signal instructing the islanded operation from the EVSE 4c, controls the power conversion of the power conversion unit 212 to generate single-phase 100 V (second voltage), and initiates the islanded operation by supplying the single-phase 100 V to the EVSE 4c (S302). Then, the flow of FIG. 10 ends.

In this way, the EVSE 4c according to the third embodiment, irrespective of the presence or absence of the neutral point connection switch 213, switches the connection with the consumer side from the single-phase three-wire 200 V system for the grid-connected operation or the grid-interconnection operation to the single-phase 100 V system for the islanded operation in a case where it determines that the islanded operation is to be performed.

This configuration enables both the single-phase 200 V charging (grid-connected operation) and the islanded operation in which a 100 V device is usable.

Moreover, in the present disclosure, the expression “whether or not A” shall encompass at least any one of a determination that “A” holds and a determination that “A” does not hold. In other words, in each of the embodiments described above, the determination of “whether or not A” may be implemented by determining that “A” holds, by determining that “A” does not hold, or by both.

The programs executed by each device in the power system 1 according to the present disclosure may also be provided by being recorded, in an installable file format or in an executable file format, on a non-transitory computer-readable recording medium such as a CD-ROM, FD, CD-R, or DVD, and provided.

Further, the programs executed by each device of the power system 1 according to the present disclosure may also be provided by being stored on a computer connected to a network such as the Internet and downloaded via the network. Alternatively, the programs executed by each device of the power system 1 according to the present disclosure may be provided or distributed via a network such as the Internet.

Furthermore, the programs executed by each device of the power system 1 according to the present disclosure may also be provided by being pre-installed in ROM or the like.

According to at least one of the embodiments described above, it is possible for a consumer receiving power supply from a single-phase three-wire power grid to utilize an on-board battery as a power source.

According to the present disclosure, it is possible for a consumer receiving power supply from a single-phase three-wire power grid to use an on-board battery as a power source.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Additional Notes

According to the foregoing description, the following technologies of the present disclosure are provided.
(A1)

A power conversion device including:
a power conversion unit including an AC-side input/output terminal electrically connected to a charge/discharge socket to which a charge/discharge cable is detachably connected to input and output AC power, and a DC-side input/output terminal configured to input and output DC power, the power conversion unit being configured to convert power input from one of the AC-side input/output terminal and the DC-side input/output terminal between AC power and DC power and output converted power from another of the AC-side input/output terminal and the DC-side input/output terminal;
a neutral point connection switch disposed between a neutral point of a pair of power lines of the AC-side input/output terminal and a functional grounding line at a chassis potential electrically connected to a protective earth line of the charge/discharge cable connected to the charge/discharge socket; and
a first control unit configured to control operations of the power conversion unit and the neutral point connection switch,
in which the first control unit is configured to control an islanded operation causing the power conversion unit to convert DC power input from the DC-side input/output terminal into AC power to output the AC power from the AC-side input/output terminal with the neutral point connection switch kept on by the first controller to establish conduction between the neutral point of the AC-side input/output terminal and the functional grounding line at the chassis potential.
(A2)

The power conversion device according to (A1), in which
the AC power output from the AC-side input/output terminal in the islanded operation includes a first voltage which is a potential difference between the pair of power lines of the AC-side input/output terminal, and a second voltage which is a potential difference between each of the pair of power lines of the AC-side input/output terminal and the neutral point, and
an amplitude of the first voltage is twice an amplitude of the second voltage.
(A3)

The power conversion device according to (A1) or (A2), in which
the first control unit is further configured to control a grid-connected operation causing the power conversion unit to convert AC power input from the AC-side input/output terminal into DC power to output the DC power from the DC-side input/output terminal with the neutral point connection switch kept off by the first controller to disconnect the neutral point of the AC-side input/output terminal and the functional grounding line at the chassis potential.
(A4)

The power conversion device according to any one of (A1) to (A3), in which
the first control unit is further configured to control a grid-interconnection operation causing the power conversion unit to convert DC power input from the DC-side input/output terminal into AC power to output the AC power from the AC-side input/output terminal with the neutral point connection switch kept off by the first controller to disconnect the neutral point of the AC-side input/output terminal and the functional grounding line at the chassis potential.
(A5)

The power conversion device according to any one of (A1) to (A4), further including
a current sensor disposed in series with the functional grounding line at the chassis potential,
in which the first control unit is configured to stop the islanded operation in a case where a current greater than or equal to a predetermined threshold is detected by the current sensor in a state where the neutral point connection switch is turned on.
(A6)

A vehicle including:
the power conversion device according to any one of (A1) to (A5);
a battery electrically connected to the DC-side input/output terminal; and
the charge/discharge socket, in which
the charge/discharge socket includes:
   a pair of power terminals electrically connected to a pair of power lines of the charge/discharge cable;
   a protective earth terminal electrically connected to the protective earth line of the charge/discharge cable; and
   a control terminal electrically connected to a control line of the charge/discharge cable,
the pair of power terminals of the charge/discharge socket are electrically connected to the pair of power lines of the AC-side input/output terminal of the power conversion device,
the protective earth terminal of the charge/discharge socket is electrically connected to the functional grounding line at the chassis potential, and
the control terminal of the charge/discharge socket is electrically connected to the first control unit of the power conversion device and configured to input a control signal from outside via the charge/discharge cable.
(A7)

The vehicle according to (A6), in which
the first control unit of the power conversion device is configured to turn on the neutral point connection switch in a case where the islanded operation is instructed by the control signal from the outside.
(A8)

A power system including:
a first vehicle being the vehicle according to (A6);
a power supply apparatus electrically connected to the vehicle via the charge/discharge cable;
a first distribution board disposed between a power grid and the power supply apparatus; and
a second distribution board disposed between the first distribution board and the power supply apparatus, in which the power supply apparatus includes:
   a grid-side switch disposed between the first distribution board and the charge/discharge cable;
   an islanded-side switch disposed between the second distribution board and the charge/discharge cable; and
   a second control unit configured to control operations of the grid-side switch and the islanded-side switch, in which
the second control unit is configured to:
   control a grid-connected operation or a grid-interconnection operation with the grid-side switch kept on by the second controller to establish conduction between the first distribution board and the charge/discharge cable in a case where the first vehicle is connected via the charge/discharge cable, the grid-connected operation supplying AC power supplied from the power grid via the first distribution board to the first vehicle connected via the charge/discharge cable, the grid-interconnection operation supplying AC power supplied from the first vehicle via the charge/discharge cable to the first distribution board; and
   control, in a case where a power failure of the power grid is detected, an islanded operation outputting a control signal instructing the islanded operation to the first control unit of the power conversion device mounted on the first vehicle connected via the charge/discharge cable to supply AC power supplied from the first vehicle via the charge/discharge cable to the second distribution board with the islanded-side switch kept on by the second controller to establish conduction between the second distribution board and the charge/discharge cable.
(A9)

The power system according to (A8), in which
the first control unit of the power conversion device in the first vehicle is configured to turn on the neutral point connection switch in a case where the islanded operation is instructed by the control signal from the outside.
(A10)

The power system according to (A8) or (A9), in which
in a case where a second vehicle in which the power conversion device that does not include the neutral point connection switch is mounted is connected via the charge/discharge cable, the second control unit is configured to control a grid-connected operation or a grid-interconnection operation with the grid-side switch kept on by the second controller to establish conduction between the first distribution board and the charge/discharge cable, the grid-connected operation supplying AC power supplied from the power grid via the first distribution board to the second vehicle connected via the charge/discharge cable, the grid-interconnection operation supplying AC power supplied from the second vehicle via the charge/discharge cable to the first distribution board.
(A11)

The power system according to any one of (A8) to (A10), in which
in a case where a power failure of the power grid is detected, the second control unit is configured to check whether the neutral point connection switch is present in a vehicle to which the charge/discharge cable is connected, and not to output the control signal instructing the islanded operation in a case where the neutral point connection switch is not present.
(B1)

A power supply apparatus including:
a charge/discharge cable having a pair of power lines, a protective earth line at ground potential, and a control line;
a grid-side switch disposed between a grid-side input/output terminal electrically connected to a power grid via a first distribution board and the charge/discharge cable;
an islanded-side switch disposed between an output terminal for islanded operation electrically connected to a second distribution board different from the first distribution board and the charge/discharge cable; and
a second control unit configured to control operations of the grid-side switch and the islanded-side switch and to communicate via the control line with a first control unit of a power conversion device mounted on a vehicle to which the charge/discharge cable is connected, in which
a pair of voltage lines of the grid-side input/output terminal are electrically connected to a pair of power lines of the charge/discharge cable via the grid-side switch,
a pair of voltage lines of an islanded-side output terminal are electrically connected to the pair of power lines of the charge/discharge cable via the islanded-side switch,
the pair of power lines of the charge/discharge cable are electrically connected to a pair of power lines of an AC-side input/output terminal configured to input and output AC power in the power conversion device of the vehicle to which the charge/discharge cable is connected,
a neutral line of the grid-side input/output terminal and the protective earth line of the charge/discharge cable are connected to a ground potential,
the second control unit is configured to:
   in a case where the vehicle is connected via the charge/discharge cable, control a grid-connected operation or a grid-interconnection operation with the grid-side switch kept on by the second controller to establish conduction between the first distribution board and the charge/discharge cable, the grid-connected operation supplying AC power at a first voltage supplied from the power grid via the first distribution board to the vehicle to which the charge/discharge cable is connected, the grid-interconnection operation supplying AC power at the first voltage supplied from the vehicle via the charge/discharge cable to the first distribution board; and
   in a case where a power failure of the power grid is detected, control an islanded operation outputting a control signal instructing the islanded operation to the first control unit of the power conversion device mounted on the vehicle to which the charge/discharge cable is connected to supply AC power from the vehicle via the charge/discharge cable to the second distribution board with the islanded-side switch kept on by the second controller to establish conduction between the second distribution board and the charge/discharge cable, and
the control signal instructing the islanded operation is configured to specify, as an output voltage value, a second voltage that is a potential difference between each of the pair of voltage lines of the grid-side input/output terminal and a neutral line of the grid-side input/output terminal in the grid-connected operation or the grid-interconnection operation.
(B2)

The power supply apparatus according to (B1), in which
a neutral line of the islanded-side output terminal is electrically connected to the protective earth line of the charge/discharge cable via the islanded-side switch,
the protective earth line of the charge/discharge cable is electrically connected to a functional grounding line at a chassis potential in the power conversion device of the vehicle to which the charge/discharge cable is connected,
the second control unit is configured to check whether a neutral point connection switch is disposed between a neutral point of the pair of power lines of the AC-side input/output terminal of the power conversion device and the functional grounding line at the chassis potential in the power conversion device of the vehicle to which the charge/discharge cable is connected,
the control signal instructing the islanded operation is configured to:
   specify, as an output voltage value, the first voltage which is a potential difference between the pair of voltage lines of the grid-side input/output terminal in the grid-connected operation or the grid-interconnection operation in a case where the vehicle connected via the charge/discharge cable is a first vehicle equipped with the neutral point connection switch, and
   specify, as the output voltage value, the second voltage in a case where the vehicle connected via the charge/discharge cable is a second vehicle not equipped with the neutral point connection switch.
(B3)

The power supply apparatus according to (B2), further including
a short-circuit switch disposed between the islanded-side output terminal and the islanded-side switch, or between the islanded-side switch and a vehicle-side input/output terminal, the short-circuit switch being configured to electrically connect one of the pair of power lines of the charge/discharge cable to one of the pair of voltage lines of the corresponding islanded-side output terminal or to a neutral line of the islanded-side output terminal via the islanded-side switch,
in which the second control unit is configured to:
   in a case where the first vehicle is connected via the charge/discharge cable, output the control signal configured to instruct the islanded operation with the short-circuit switch kept off by the second controller to electrically connect one of the pair of power lines of the charge/discharge cable to the corresponding one of the pair of voltage lines of the islanded-side output terminal; and
   in a case where the second vehicle is connected via the charge/discharge cable, output the control signal configured to instruct the islanded operation with the short-circuit switch kept on by the second controller to electrically connect one of the pair of power lines of the charge/discharge cable to the neutral line of the islanded-side output terminal.
(B4)

A power system including:
the power supply apparatus according to (B2) or (B3);
the vehicle electrically connected to the power supply apparatus via the charge/discharge cable;
the first distribution board disposed between the power grid and the power supply apparatus; and
the second distribution board disposed between the first distribution board and the power supply apparatus, in which
in the grid-connected operation or the grid-interconnection operation, a potential difference between the pair of power lines of the AC-side input/output terminal of the power conversion device of the vehicle is the first voltage,
in the islanded operation, a potential difference between the pair of power lines of the AC-side input/output terminal of the power conversion device of the first vehicle is the first voltage,
in the islanded operation, a potential difference between each of the pair of power lines of the AC-side input/output terminal of the power conversion device of the first vehicle and a neutral point of the pair of power lines of the AC-side input/output terminal is the second voltage, and
in the islanded operation, a potential difference between the pair of power lines of the AC-side input/output terminal of the power conversion device of the second vehicle is the second voltage.
(B5)

The power system according to (B4), in which
the power conversion device of the first vehicle includes the neutral point connection switch, and
the first control unit of the first vehicle is configured to turn on the neutral point connection switch to establish conduction between the neutral point of the AC-side input/output terminal of the power conversion device and the functional grounding line at the chassis potential in the islanded operation, and turn off the neutral point connection switch to disconnect the neutral point of the AC-side input/output terminal of the power conversion device and the functional grounding line at the chassis potential in the grid-interconnection operation or the grid-connected operation.
(B6)

A power system including:
the power supply apparatus according to (B1);
the vehicle electrically connected to the power supply apparatus via the charge/discharge cable;
the first distribution board disposed between the power grid and the power supply apparatus; and
the second distribution board, in which
in the grid-connected operation or the grid-interconnection operation, a potential difference between the pair of power lines of the AC-side input/output terminal of the power conversion device of the vehicle is the first voltage, and
in the islanded operation, a potential difference between the pair of power lines of the AC-side input/output terminal of the power conversion device of the vehicle is the second voltage.
(B7)

The power system according to (B6), in which
the vehicle is a first vehicle equipped with the power conversion device in which the neutral point connection switch is disposed between a neutral point of the pair of power lines of the AC-side input/output terminal and the functional grounding line at the chassis potential, and
the first control unit of the first vehicle is configured to turn on the neutral point connection switch to establish conduction between the neutral point of the AC-side input/output terminal of the power conversion device and the functional grounding line at the chassis potential in the islanded operation, and turn off the neutral point connection switch to disconnect the neutral point of the AC-side input/output terminal of the power conversion device and the functional grounding line at the chassis potential in the grid-interconnection operation or the grid-connected operation.

What is claimed is:

1. A power conversion device comprising:
a power convertor comprising an AC-side input/output terminal electrically connected to a charge/discharge socket to which a charge/discharge cable is detachably connected to input and output AC power, and a DC-side input/output terminal configured to input and output DC power, the power convertor being configured to convert power input from one of the AC-side input/output terminal and the DC-side input/output terminal between AC power and DC power and output converted power from another of the AC-side input/output terminal and the DC-side input/output terminal;
a neutral point connection switch disposed between a neutral point of a pair of power lines of the AC-side input/output terminal and a functional grounding line at a chassis potential electrically connected to a protective earth line of the charge/discharge cable connected to the charge/discharge socket; and
a first controller configured to control operations of the power convertor and the neutral point connection switch,
wherein the first controller is configured to control an islanded operation causing the power convertor to convert DC power input from the DC-side input/output terminal into AC power to output the AC power from the AC-side input/output terminal with the neutral point connection switch kept on by the first controller to establish conduction between the neutral point of the AC-side input/output terminal and the functional grounding line at the chassis potential.

2. The power conversion device according to claim 1, wherein
the AC power output from the AC-side input/output terminal in the islanded operation comprises a first voltage which is a potential difference between the pair of power lines of the AC-side input/output terminal, and a second voltage which is a potential difference between each of the pair of power lines of the AC-side input/output terminal and the neutral point, and
an amplitude of the first voltage is twice an amplitude of the second voltage.

3. The power conversion device according to claim 1, wherein
the first controller is further configured to control a grid-connected operation causing the power convertor to convert AC power input from the AC-side input/output terminal into DC power to output the DC power from the DC-side input/output terminal with the neutral point connection switch kept off by the first controller to disconnect the neutral point of the AC-side input/output terminal and the functional grounding line at the chassis potential.

4. The power conversion device according to claim 1, wherein
the first controller is further configured to control a grid-interconnection operation causing the power convertor to convert DC power input from the DC-side input/output terminal into AC power to output the AC power from the AC-side input/output terminal with the neutral point connection switch kept off by the first controller to disconnect the neutral point of the AC-side input/output terminal and the functional grounding line at the chassis potential.

5. The power conversion device according to claim 1, further comprising
a current sensor disposed in series with the functional grounding line at the chassis potential,
wherein the first controller is configured to stop the islanded operation in a case where a current greater than or equal to a predetermined threshold is detected by the current sensor in a state where the neutral point connection switch is turned on.

6. A vehicle comprising:
the power conversion device according to claim 1;
a battery electrically connected to the DC-side input/output terminal; and
the charge/discharge socket, wherein
the charge/discharge socket comprises:
a pair of power terminals electrically connected to a pair of power lines of the charge/discharge cable;
a protective earth terminal electrically connected to the protective earth line of the charge/discharge cable; and
a control terminal electrically connected to a control line of the charge/discharge cable,
the pair of power terminals of the charge/discharge socket are electrically connected to the pair of power lines of the AC-side input/output terminal of the power conversion device,
the protective earth terminal of the charge/discharge socket is electrically connected to the functional grounding line at the chassis potential, and
the control terminal of the charge/discharge socket is electrically connected to the first controller of the power conversion device and configured to input a control signal from outside via the charge/discharge cable.

7. The vehicle according to claim 6, wherein
the first controller of the power conversion device is configured to turn on the neutral point connection switch in a case where the islanded operation is instructed by the control signal from the outside.

8. A power system comprising:
a first vehicle being the vehicle according to claim 6;
a power supply apparatus electrically connected to the vehicle via the charge/discharge cable;
a first distribution board disposed between a power grid and the power supply apparatus; and
a second distribution board disposed between the first distribution board and the power supply apparatus, wherein
the power supply apparatus comprises:
a grid-side switch disposed between the first distribution board and the charge/discharge cable;
an islanded-side switch disposed between the second distribution board and the charge/discharge cable; and
a second controller configured to control operations of the grid-side switch and the islanded-side switch, wherein
the second controller is configured to:
control a grid-connected operation or a grid-interconnection operation with the grid-side switch kept on by the second controller to establish conduction between the first distribution board and the charge/discharge cable in a case where the first vehicle is connected via the charge/discharge cable, the grid-connected operation supplying AC power supplied from the power grid via the first distribution board to the first vehicle connected via the charge/discharge cable, the grid-interconnection operation supplying AC power supplied from the first vehicle via the charge/discharge cable to the first distribution board; and
control, in a case where a power failure of the power grid is detected, an islanded operation outputting a control signal instructing the islanded operation to the first controller of the power conversion device mounted on the first vehicle connected via the charge/discharge cable to supply AC power supplied from the first vehicle via the charge/discharge cable to the second distribution board with the islanded-side switch kept on by the second controller to establish conduction between the second distribution board and the charge/discharge cable.

9. The power system according to claim 8, wherein
the first controller of the power conversion device in the first vehicle is configured to turn on the neutral point connection switch in a case where the islanded operation is instructed by the control signal from the outside.

10. The power system according to claim 8, wherein
in a case where a second vehicle in which the power conversion device that does not comprise the neutral point connection switch is mounted is connected via the charge/discharge cable, the second controller is configured to control a grid-connected operation or a grid-interconnection operation with the grid-side switch kept on by the second controller to establish conduction between the first distribution board and the charge/discharge cable, the grid-connected operation supplying AC power supplied from the power grid via the first distribution board to the second vehicle connected via the charge/discharge cable, the grid-interconnection operation supplying AC power supplied from the second vehicle via the charge/discharge cable to the first distribution board.

11. The power system according to claim 8, wherein
in a case where a power failure of the power grid is detected, the second controller is configured to check whether the neutral point connection switch is present in a vehicle to which the charge/discharge cable is connected, and not to output the control signal instructing the islanded operation in a case where the neutral point connection switch is not present.
